(19) United States
(12) Patent Application Publication
(10) Pub. No.: US 2020/0378174 A1
(43) Pub. Date: Dec. 3, 2020

(54) SURFACE-MOUNTED WINDOW COVERING

(71) Applicant: HighLite, Inc., Mesquite, TX (US)

(72) Inventor: STEPHEN T. VASTINE, MESQUITE, TX (US)

(21) Appl. No.: 16/890,903

(22) Filed: Jun. 2, 2020

Related U.S. Application Data
(60) Provisional application No. 62/856,634, filed on Jun. 3, 2019.

(51) Int. Cl. E06B 1/34; E05F 11/18

(52) U.S. Cl. CPC E06B 1/34; E05Y 2900/148; E05Y 2201/626; E05F 11/18

(57) ABSTRACT

Window coverings configured for mounting on a wall. The window coverings may be installed directly on a wall surface such that they cover a window without requiring attachment, or other engagement, to an opening in the wall housing a window or to the window itself. The window coverings allow for manual control of light passage through the coverings.

### CITATION TO PRIOR APPLICATIONS

The present application claims priority to U.S. Provisional Application No. 62/856,634 titled “SURFACE-MOUNTED WINDOW COVERING” and filed Jun. 3, 2019.

### TECHNICAL FIELD

The present disclosure generally relates to coverings for windows.

### BACKGROUND AND SUMMARY OF THE INVENTION

Coverings for windows are conventionally designed and built to accommodate particular shapes and dimensions. As these shapes and dimensions may vary dramatically, there is a need in the art for a window covering capable of simple and efficient installation across a range of window sizes. This need is felt particularly strongly with respect to windows having rounded tops that require a correspondingly rounded window covering to maximize aesthetic compatibility.

The present disclosure introduces various illustrative embodiments of a wall-mounted, semi-circular design that address these concerns. It is on object of the present disclosure to provide a window covering that may be surface mounted to facilitate installation. Embodiments of these window coverings may be configured such that installation is possible across a range of window sizes.

### BRIEF DESCRIPTION OF THE DRAWINGS

The following figures are included to illustrate certain aspects of the present disclosure, and should not be viewed as exclusive embodiments. These subject matter disclosed is capable of considerable modification, alteration, and equivalents in form and function, as will occur to one having ordinary skill in the art and the benefit of this disclosure.

FIG. 1 is a front view of one embodiment of a surface-mounted window covering in accordance with the present disclosure.

FIG. 2 is a back view of one embodiment of a movable panel in accordance with the present disclosure.

FIG. 3 is a front view of one embodiment of a front cover in accordance with the present disclosure.

FIG. 4 depicts one embodiment of a panel lever in accordance with the present disclosure.

FIG. 5 is a front perspective view of one embodiment of a surface-mounted window covering in accordance with the present disclosure.

FIG. 6 is a rear perspective view of one embodiment of a surface-mounted window covering in accordance with the present disclosure.

### DETAILED DESCRIPTION OF EMBODIMENTS OF THE INVENTION

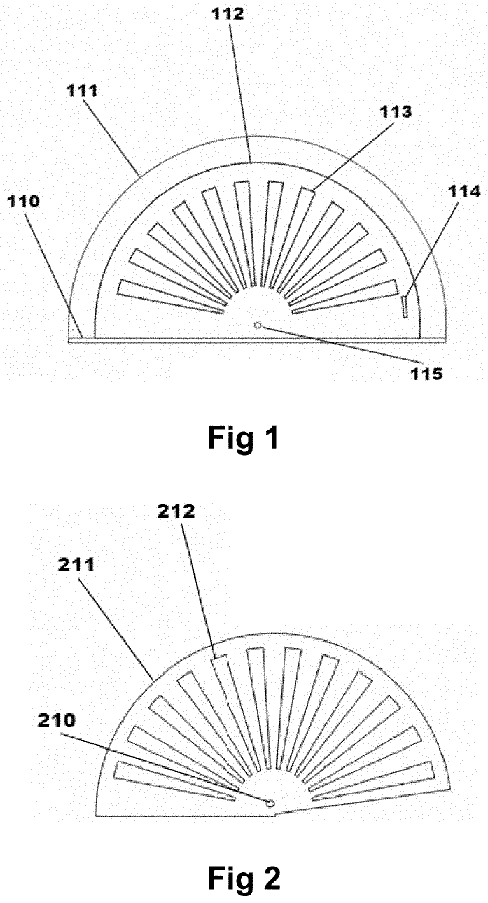

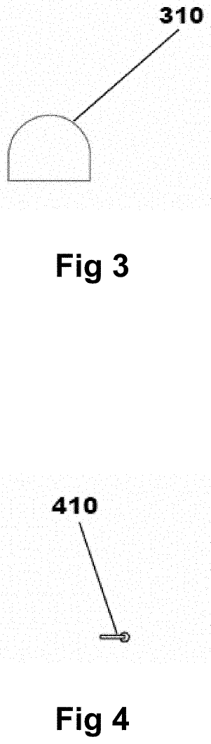

The present disclosure relates generally to surface-mounted window coverings. In certain embodiments, a surface-mounted window covering comprises three primary components: a base panel, a movable panel, and actuation means. These, and other, embodiments will now be described in reference to FIGS. 1-4.

In one embodiment, the window covering is substantially semi-circular in shape. In this embodiment, the window covering is sized such that it may be mounted on a wall that defines a window opening. The window covering extends across the window opening without protruding inward into it relative the wall. This design allows for simpler installation and manufacture as the present window covering may be applied to windows of varying sizes unlike prior art window coverings that were installed inside window openings and required custom dimensions for proper fitting.

The base panel comprises a frame 111 with a permanently attached front portion 112 that is louvered—containing openings 113 (sometimes referred to here as “lights”). The base panel may have a solid, horizontal bottom beam 110 attached to its bottom side to prevent warpage and to enhance rigidity.

In certain embodiments, a movable panel 211 is attached to the base panel at a pivot point 115 in substantially the center of the lower body of the base panel. A corresponding attachment point 210 is located on the movable panel. Movable panel 211 may also have openings 212 that correspond to the openings contained in the base panel such that the openings from both panels may overlap to allow light to pass through them or, when actuated, may be blocked by solid portions of the respective corresponding panel to prevent the passage of light through the openings.

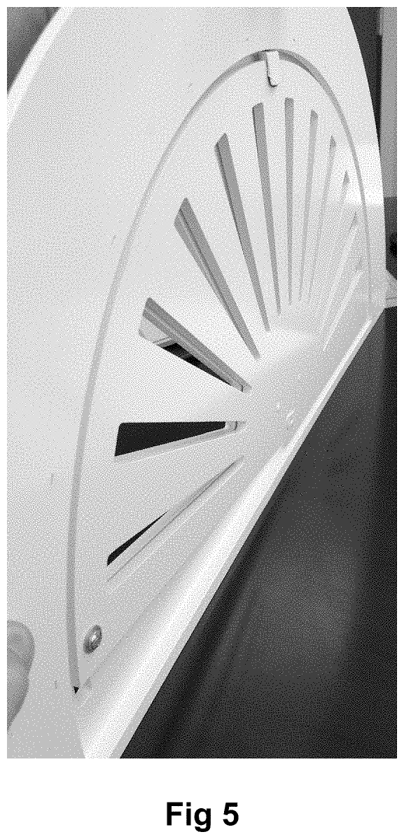

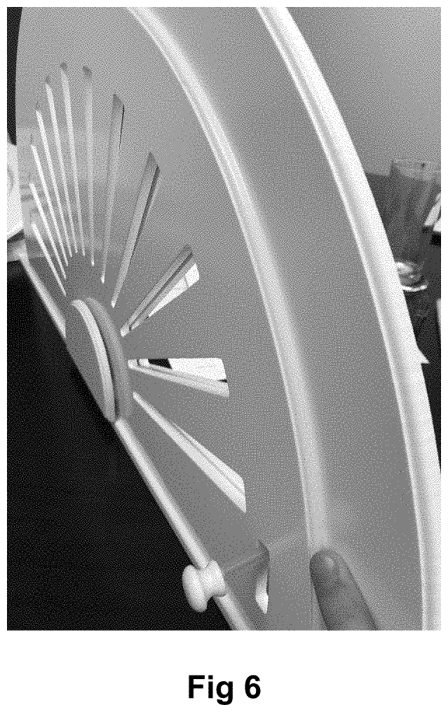

In one embodiment, as depicted in FIG. 6, front portion 112 is recessed relative to the frame of said base panel. In this embodiment, the pivot point as located at the substantial center of the recessed front portion. As shown in FIG. 5, movable panel 211 may be arranged within the volume defined by recess between frame 211 and front portion 112. Along the interior surface wall between the frame and said recessed front portion, similarly depicted in FIG. 5, securing means are attached to securely hold movable panel 211 against the front portion and minimize light gaps. In certain embodiments the securing means are fitted brackets though those skilled in the art would recognize other similar structures may be employed. As the specific dimensions of a window covering of the present design may vary, the number of brackets (or other securing means) may correspondingly vary. In a preferred embodiment, three to five brackets are evenly spaced alongside the interior surface wall though fewer or more may be used depending on the size and composition of the components.

In one embodiment of the window covering, the window covering further comprises a front cover 310 (sometimes called a “moon”) that fits on a front side of the base panel that is opposite a back side of the base panel (to which movable panel 211 is affixed). Front cover 310 disguises the screw forming the pivot point at which the base panel and movable panel 211 are attached. The front cover may be replaceably attached to the base panel to allow for tension adjustment of the screw over time.

In certain embodiments, the window covering further comprises actuation means that cause movable panel 211 to shift in order to cover or uncover the base panel lights as desired. In one embodiment, the actuation means is a lever assembly located on the base panel that includes a lever slot through which a corresponding panel lever 410, affixed to movable panel 211, may be accessed to cause manual rotation of movable panel 211. Persons of ordinary skill in the art would recognize that other actuation means may be employed to cause the movable panel to rotate, or otherwise shift, including springs, cranks, and electronic motors.

In certain embodiments, the window covering, or its various components, may be composed of wood, polymers, or any other materials known in the art. In a preferred embodiment, lightweight polymers are used to simplify wall-mounting during installation.

The various embodiments described herein may be installed in accordance with conventional techniques utilized to mount objects to walls. These embodiments, featuring a movable panel in a recessed front portion of a base panel, allow for a complete flush-mount operation wherein the window covering may be installed directly on a wall and easily manipulated to control light passage through the covering. Moreover, embodiments of a surface-mounted window covering in accordance with the present disclosure can be mounted on a wall where no window exists and remain fully functional. Such embodiments may be made or manufactured in a stock formatted with a limited amount of size options necessary while still facilitating the effective covering of arched windows of virtually any size.

Although the disclosure has been described and illustrated with respect to exemplary objects thereof, it will be understood by those skilled in the art that various other changes, omissions, and additions may be made therein and thereto without departing from the scope of the present disclosure.

1. A window covering system comprising:
a base panel configured for mounting on a wall;
a movable panel coupled to said base panel; and
actuation means for causing said movable panel to move relative said base panel.

2. The system of claim 1 wherein said base panel comprises a frame and a recessed front portion, and wherein said movable panel is disposed within a volume defined by said frame and said recessed front portion.

3. The system of claim 2 wherein said movable panel is configured for rotation relative said base panel.

4. The system of claim 3 wherein said actuation means is a lever assembly comprising a lever aperture disposed in said base panel and a lever configured to cause movement of said movable panel relative said base panel upon actuation of said lever, and wherein said lever extends from said movable panel through said lever aperture.

5. The system of claim 4 further comprising a front cover.

6. The system of claim 5 wherein said base panel is semi-circular in shape.
